(19) United States
(12) Patent Application Publication
(10) Pub. No.: US 2015/0205561 A1
(43) Pub. Date: Jul. 23, 2015

(54) MULTIPLE DISPLAY ALIGNMENT

(71) Applicant: Google Inc., Mountain View, CA (US)

(72) Inventors: Michael Salomon MORTON, Lyme, NH (US); Jeremy Faller, Arlington, MA (US)

(73) Assignee: Google Inc., Mountain View, CA (US)

(21) Appl. No.: 13/783,147

(22) Filed: Mar. 1, 2013

(51) Int. Cl. G06F 3/14

(52) U.S. Cl. CPC G06F 3/1423

(57) ABSTRACT

Methods for configuring multiple displays for use with a device are provided. In one aspect, a method includes providing, for display, at least one indicator on each of a plurality of displays, each display having at least one edge proximal to a corresponding edge of another display, and receiving a selection of an indicator for each of a pair of proximate edges of the plurality of displays. The method also includes receiving an indication that the selected indicators have been aligned on the plurality of displays to indicate a physical alignment of the plurality of displays, and arranging content provided for display on each of the plurality of displays based on the received indication. Systems and machine-readable media are also provided.

### BACKGROUND

1. Field

The present disclosure generally relates to electronic displays, and more particularly to the use of a computing device with multiple electronic displays.

2. Description of the Related Art

Computers may be connected to more than one display device. A user of a computer having multiple displays is typically responsible for configuring the displays for use with the computer, including indicating to the computer the physical position of the displays relative to one another (the “display arrangement”). In such circumstances, users encounter difficulty in configuring the display arrangement of multiple displays due to limitations of provided display configuration options, and therefore have difficulty properly aligning the displays. Arranging displays with a same pixel density can be relatively straightforward and may avoid having a graphical object “jump” when moved from one display to another. However, when two displays have different pixel densities, a user's best efforts to align them may prevent a “jump” at just one crossing point on the common border between the two displays.

### SUMMARY

According to one embodiment of the present disclosure, a computer-implemented method for configuring multiple displays for use with a device is provided. The method includes providing, for display, at least one indicator on each of a plurality of displays, each display having at least one edge proximal to a corresponding edge of another display, and receiving a selection of an indicator for each of a pair of proximate edges of the plurality of displays. The method also includes receiving an indication that the selected indicators have been aligned on the plurality of displays to indicate a physical alignment of the plurality of displays, and arranging content provided for display on each of the plurality of displays based on the received indication.

According to another embodiment of the present disclosure, a system for configuring multiple displays for use with a device is provided. The system includes a memory that includes instructions, and a processor. The processor is configured to execute the instructions to provide, for display, at least one indicator on each of a plurality of displays, each display having at least one edge proximal to a corresponding edge of another display, and receive a selection of an indicator includes a visual marker for each of a pair of proximate edges of the plurality of displays. The processor is also configured to execute the instructions to receive an indication that the selected indicators have been aligned on the plurality of displays to indicate a physical alignment of the plurality of displays, and arrange content provided for display on each of the plurality of displays based on the received indication.

According to a further embodiment of the present disclosure, a machine-readable storage medium includes machine-readable instructions for causing a processor to execute a method for configuring multiple displays for use with a device is provided. The method includes providing, for display, at least one indicator on each of a plurality of displays, each display having at least one edge proximal to a corresponding edge of another display, and receiving a selection of an indicator for each of a pair of proximate edges of the plurality of displays. The method also includes receiving an indication that the selected indicators have been aligned on the plurality of displays to indicate a physical alignment of the plurality of displays, and arranging content provided for display on each of the plurality of displays based on the received indication. At least two of the plurality of displays each include different pixel densities.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture for configuring multiple displays for use with a device.

FIG. 2 is a block diagram illustrating an example client from the architecture of FIG. 1 according to certain aspects of the disclosure.

FIG. 3 illustrates an example process for configuring multiple displays for use with a device using the example client of FIG. 2.

FIGS. 4A-4O are example illustrations associated with the example process of FIG. 3.

FIG. 5 is a block diagram illustrating an example computer system with which the clients of FIG. 2 can be implemented.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

The disclosed system provides an interface for arranging multiple displays that addresses both the issues of physical positioning and differing pixel densities of the displays. Specifically, the interface provided by the disclosed system provides an indicator on each of the displays and permits the user to align the indicators to indicate a physical alignment of the displays. The indicators may be generated by the user (e.g., by tapping to create an object on each display to be aligned, such as a small circle on proximate edges of each display) or generated by the interface and adjusted by the user (e.g., an arrow on each proximate edge of a display for the user to drag into physical alignment). For displays having different pixel densities, at least two indicators may be generated on each display and each indicator on each display may be aligned by the user with a corresponding indicator on the other display. Additionally, for displays having different pixel densities, an indicator of a certain length may be displayed on each display, and the indicator may be repositioned and resized by the user to match a corresponding indicator on another display. In certain aspects where the user would like to pair edges of displays to indicate their proximity to one another (e.g., when more than two displays are used), the user can indicate which edge of each display the user would like to align by, for example, clicking at or near that edge or selecting a marker displayed along that edge. Thereafter, the above-described indicators may be provided for display in order to properly configure the display arrangement.

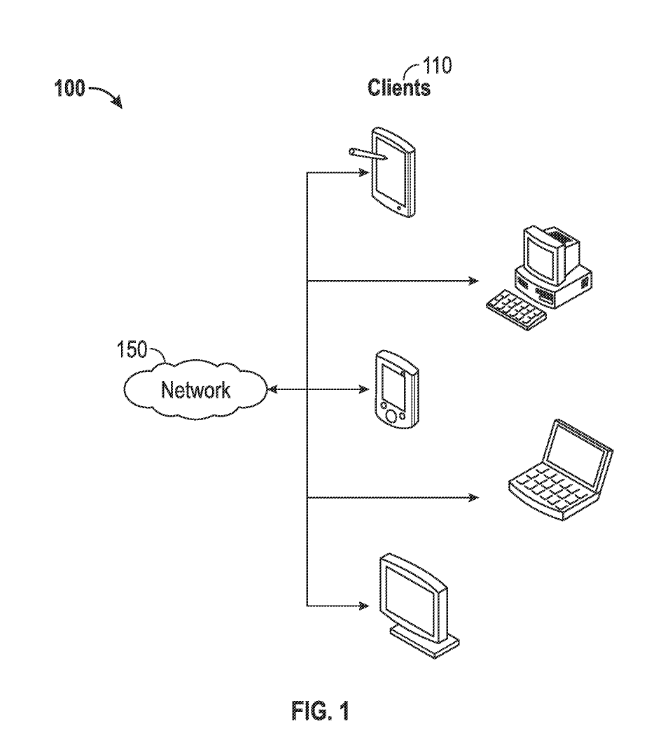

FIG. 1 illustrates an example architecture 100 for configuring multiple displays for use with a device. The architecture 100 includes clients 110 that may be connected to a network 150.

Each of the many clients 110 includes a configuration interface for configuring multiple displays for use with the client 110. Upon initiation of the configuration interface, at least one visual indicator is provided on each of at least two displays connected to a client 110. A user of the client 110 aligns the visual indicator on each display with a corresponding visual indicator on a neighboring display. The visual indicators can be aligned with one another by adjusting their position, size, or both their position and size. Once the visual indicators have been indicated as aligned by the user, the user submits the alignment configuration and the configuration interface aligns the displays accordingly. For displays having varying pixel densities (e.g., different resolutions), the user may either adjust the size of an indicator on each display to align with the size of a corresponding indicator on a neighboring display, or the user can align at least a pair of indicators with a corresponding pair of indicators on the neighboring display. If the client 110 includes more than two displays, then the user may first identify which pair of displays the user would like to align by identifying the pair of displays to the configuration interface.

In certain aspects, if the configuration interface does not exist on the client 110, the configuration interface specific to the client type can be downloaded over a network 150. The client 110 types can be, for example, desktop computer, mobile computer, tablet computer (e.g., including e-book reader), mobile device (e.g., a smartphone or PDA), set top box (e.g., for a television), video game console, or any other device having appropriate processor, memory, and communications capabilities for connecting to multiple displays. The network 150 can include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

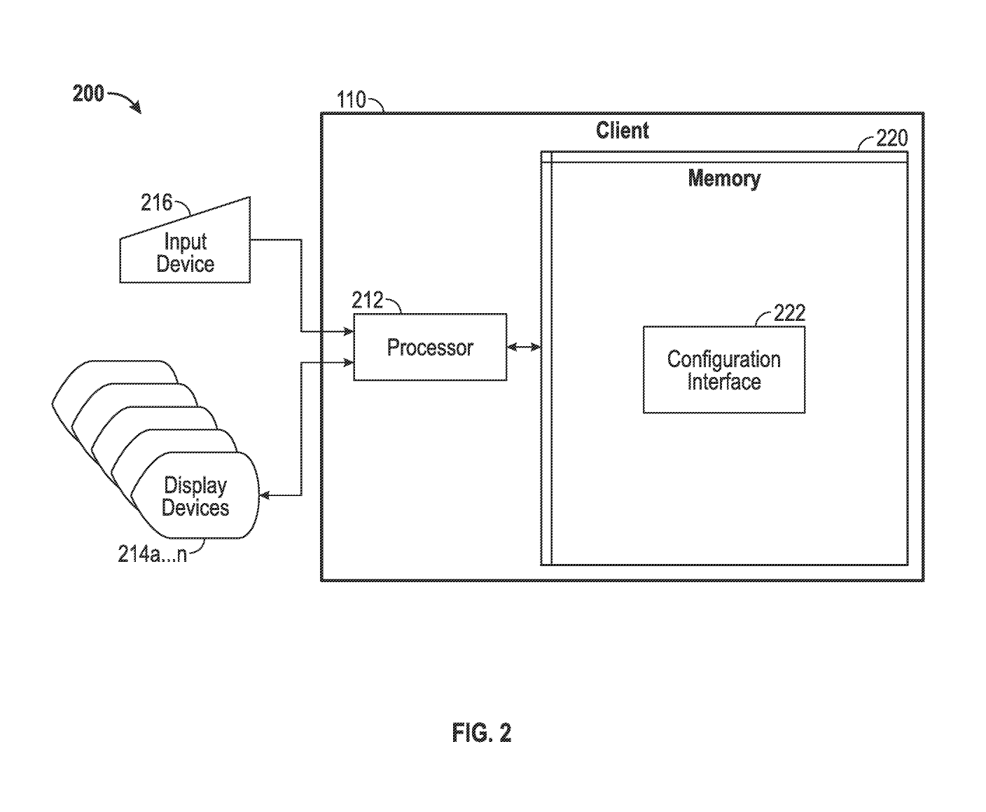

FIG. 2 is a block diagram 200 illustrating an example client 110 in the architecture 100 of FIG. 1 according to certain aspects of the disclosure. The client 110 includes a processor 212 and a memory 220 that includes a configuration interface 222. The client 110 also includes an input device 216, such as a keyboard or mouse, and multiple display devices 214a to 214n, such as LCD displays.

The processor 212 of the client 110 is configured to execute instructions, such as instructions physically coded into the processor 212, instructions received from software in memory 240, or a combination of both. For example, the processor 212 of the client 110 executes instructions to configure the multiple displays 214a to 214n for use with the client 110. For example, the processor 212 of the client 110 executes instructions from the configuration interface 222 causing the processor 212 to provide, for display, at least one indicator on each of the displays 214a to 214n. The indicator can be a visual marker such as a dot, rectangle, arrow, or other geometric or non-geometric shape. For example, when the indicator is an arrow, each arrow may be positioned in alignment with an arrow on another display 214a to 214n. In certain aspects, the indicator may automatically appear on each display 214a to 214n when the configuration interface 222 is initiated, while in certain aspects, the graphical object can be generated by a user in a position selected by the user after the configuration interface 222 is initiated.

Each display 214a to 214n has at least one edge proximal to (e.g., next to or near) a corresponding edge of another display 214a to 214n. For example, if the client 110 is connected to two displays 214a and 214b, each display 214a and 214b may have an edge that is physically next to or near an edge of the other display 214a and 214b. Similarly, if the client has three displays 214a, 214b, and 214c, then two displays 214a 214c may have one edge next to a corresponding display 214c, and the corresponding display 214c may have one edge next to or near each of the other displays 214a and 214b.

The processor 212 can display a visual bar or other marker along each edge of each display 214a to 214n, and the user can repeatedly select a bar on an edge of each of two displays 214a and 214b to indicate that the user intends to align those edges of the two displays 214a and 214b. In certain aspects, when a bar is selected on a display 214a, the other markers provided on the remaining edges of the display 214a may be dimmed or removed from the display 214a. The processor 212 may then provide a visual indicator on the two displays 214a and 214b for the user to align the two displays 214a and 214b, and then repeat the process of displaying the visual bars on each display 214a to 214n until all of the displays 214a to 214n are aligned.

In order to align a pair of displays 214a to 214n (that may have been selected from a larger group of displays 214a to 214n), the processor 212 is configured to receive a selection of an indicator for each of a pair of proximate edges of the displays 214a to 214n, receive an indication that the selected indicators have been aligned on the displays 214a to 214n to indicate a physical alignment of the displays 214a to 214n, and arrange content provided for display on each of the displays 214a to 214n based on the received indication.

In certain aspects where at least two of the displays 214a to 214n each have different pixel densities, the processor 212 is configured to display two indicators on each display 214a to 214n. The processor 212 then receives an indication that each indicator on one of displays 214a to 214n is aligned with corresponding indicators on the other display 214a to 214n. For example, after the user has aligned each indicator on one of displays 214a to 214n with corresponding indicators on the other display 214a to 214n, the user may submit the alignment (e.g., by selecting “done” or “align” in the configuration interface 222) to indicate that the indicators on the displays 214a to 214n have been aligned. In certain aspects where at least two of the displays 214a to 214n each include different pixel densities, the processor 212 is also configured to provide a single indicator on each display 214a to 214n. The single indicator for each display 214a to 214n has a length and position along the proximal edge of the displays 214a to 214n that can be adjusted by the user to align with the length and position of an indicator along the proximal edge of a corresponding display 214a to 214n. When the single indicators for each display 214a to 214n are aligned, the user may submit the alignment to indicate that the indicators on the displays 214a to 214n have been aligned

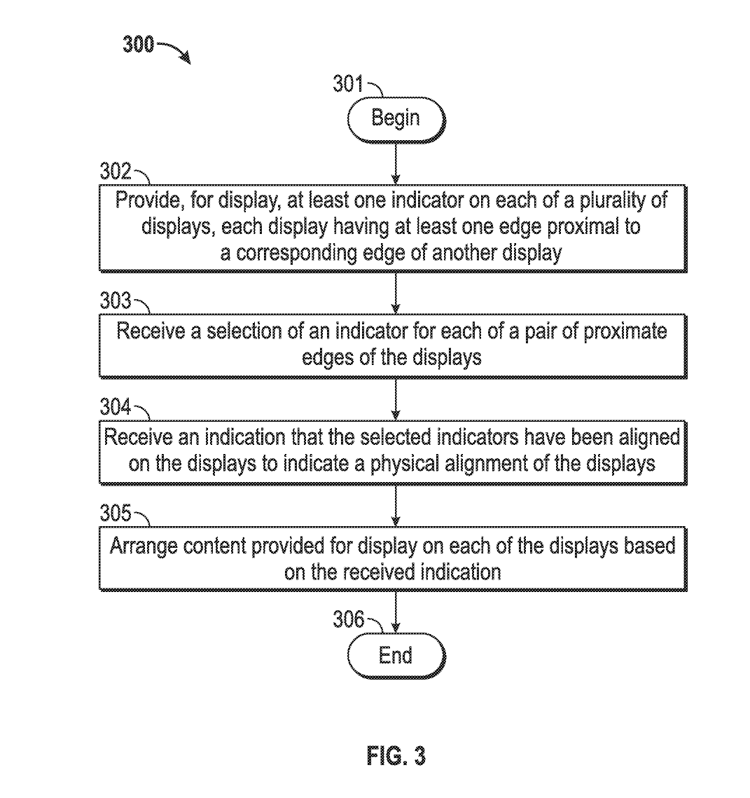

FIG. 3 illustrates an example process 300 for configuring multiple displays for use with a device using the example client 110 of FIG. 2. While FIG. 3 is described with reference to FIG. 2, it should be noted that the process steps of FIG. 3 may be performed by other systems. The process 300 begins by proceeding from beginning step 301 when the configuration interface 222 is initiated to step 302 when at least one indicator is provided for display on each of a plurality of displays 214a to 214n. Each display 214a to 214n has at least one edge proximal to a corresponding edge of another display 214a to 214n. In step 303, a selection of an indicator is received for each of a pair of proximate edges of the displays 214a to 214n, and in step 304 an indication that the selected indicators have been aligned on the displays 214a to 214n is received to indicate a physical alignment of the displays 214a to 214n. Finally, in step 305, content provided for display on each of the displays is arranged based on the received indication, and the process 300 ends in step 306.

FIG. 3 sets forth an example process 300 for configuring multiple displays for use with a device using the example client 110 of FIG. 2. Examples will now be described using the example process 300 of FIG. 3, and various arrangements of displays differing in number or pixel density.

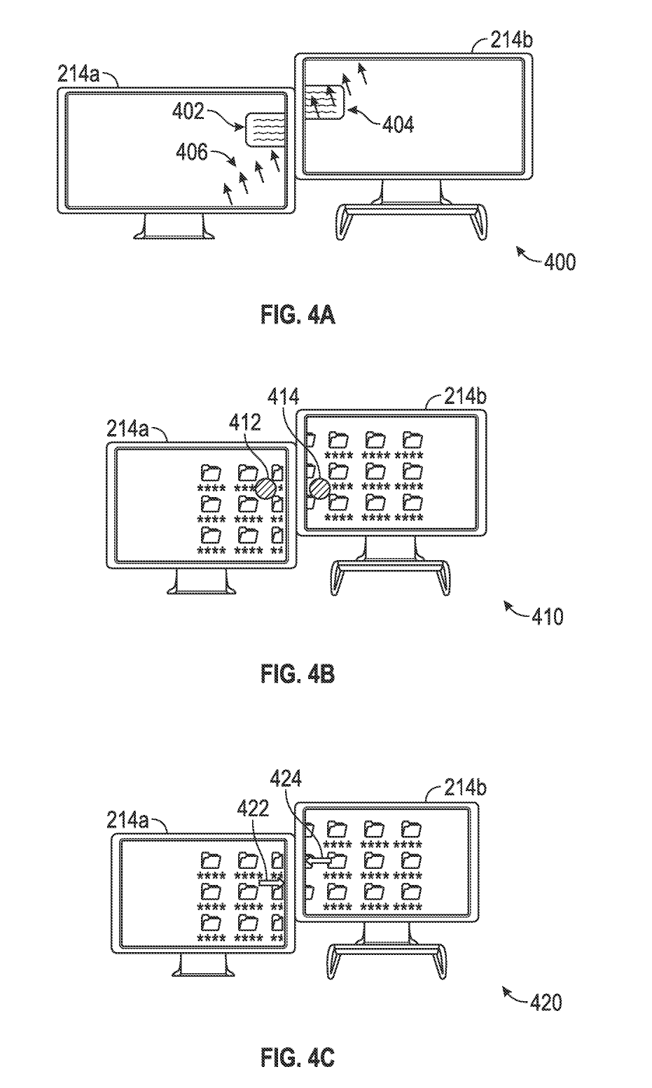

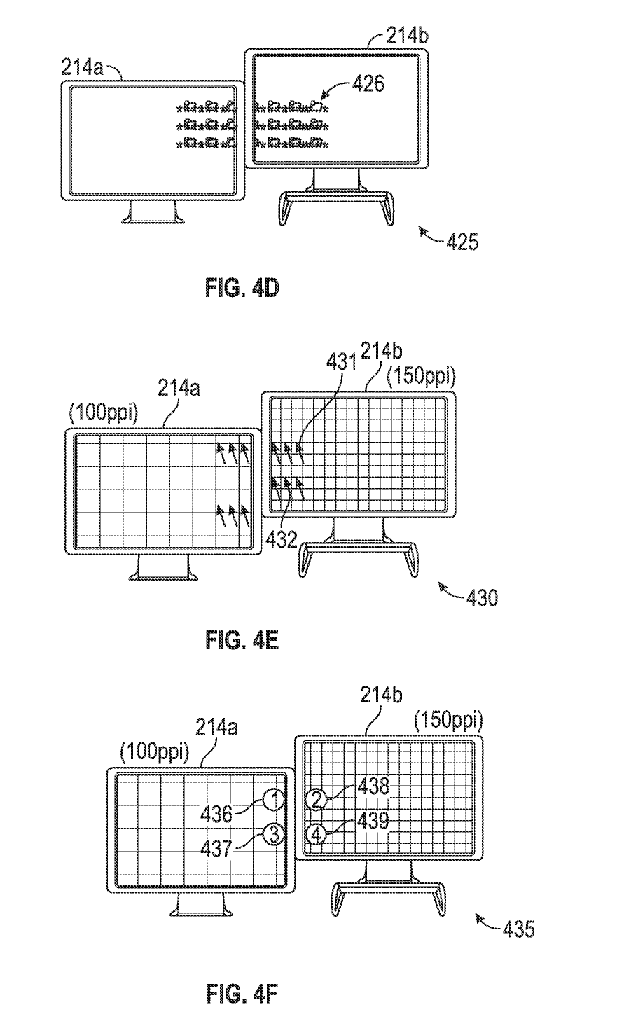

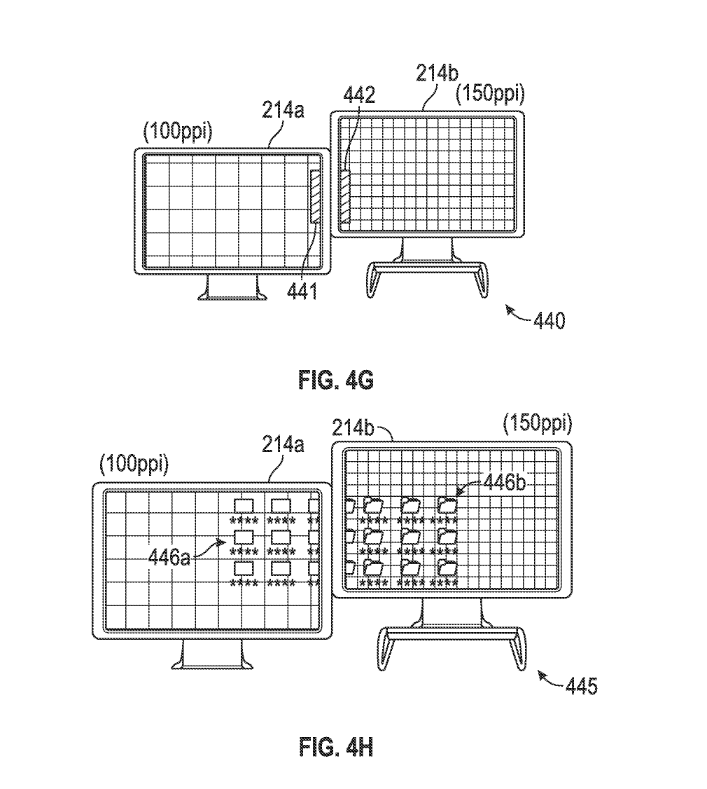

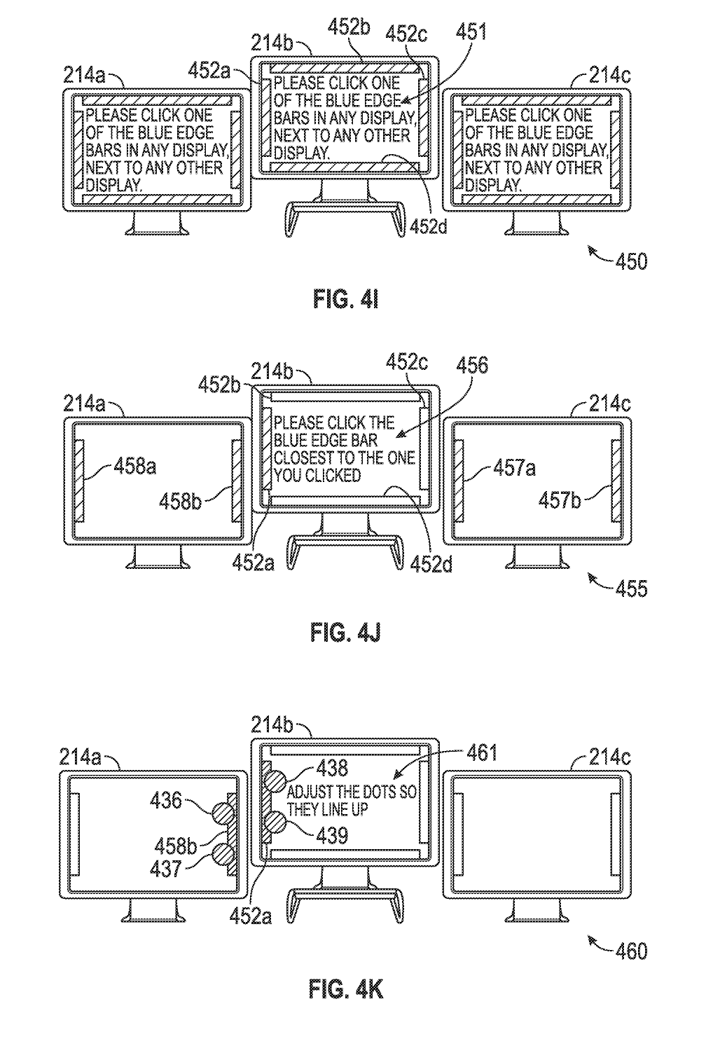

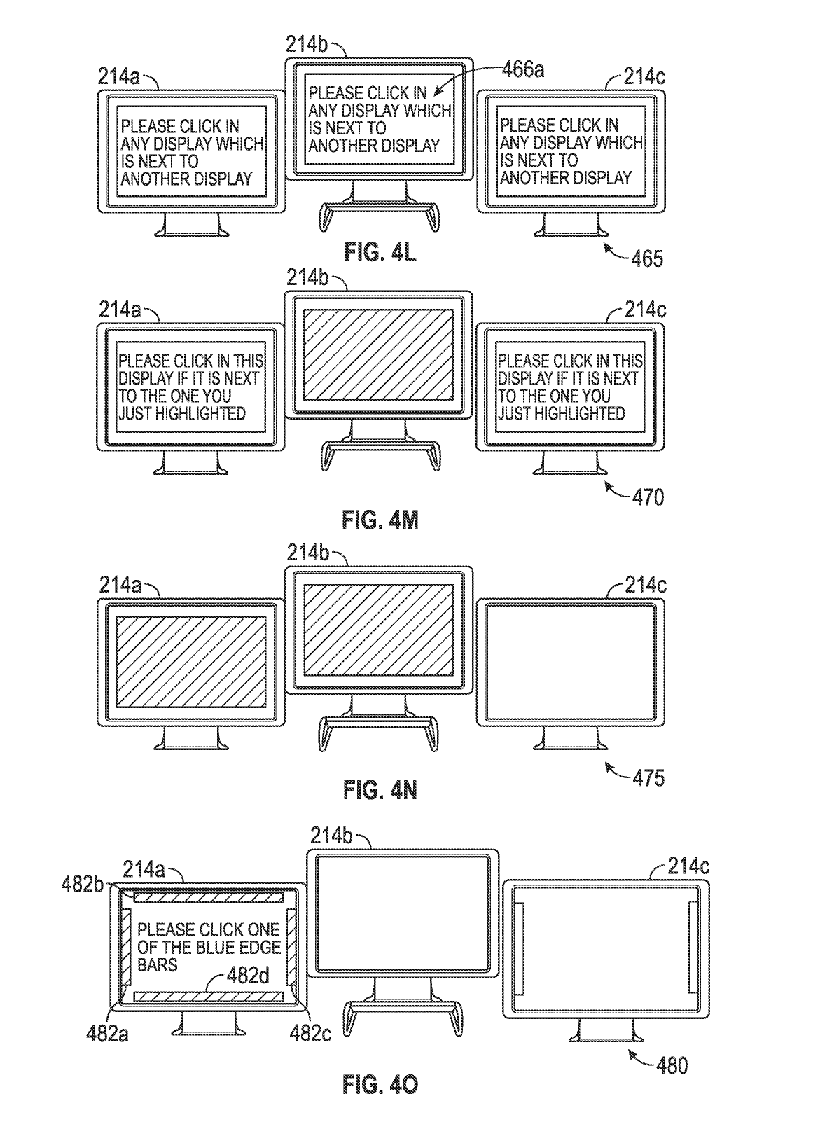

FIGS. 4A-4D provide example illustrations of configuring two displays 214a and 214b having the same pixel density. With reference to the process 300 of FIG. 3, the process 300 begins by proceeding from beginning step 301 when the configuration interface 222 is initiated. When the configuration interface 222 is initiated, the configuration of the displays 214a and 214b is not aligned, as illustrated by the misalignment of the window 402 and 404 in respective displays 214a and 214b, and the mouse trail 406 that jumps positions between the two displays 214a and 214b as provided in the illustration 400 of FIG. 4A.

Next, in step 302, a circular indicator 412 and 414 is generated by a user at aligned positions on proximate edges of the displays 214a and 214b as provided in the example illustration 410 of FIG. 4B, with the position of the generated circular indicators 412 and 414 indicating a selection proximate edges of the displays 214a and 214b in step 303.

Alternatively, for steps 302 and 303, in step 302 an arrow indicator 422 and 424 may be provided for display on each of displays 214a and 214b as illustrated in the example illustration 420 of FIG. 4C. In step 303, the user selects one arrow indicator 422 to align with the other arrow indicator 424 on proximate edges of the displays 214a and 214b.

Moving forward in the process 300, in step 304, an indication that the two indicators 412 and 414 or 422 and 424 have been aligned on the displays 214a and 214b is received by the user hitting enter on the keyboard input device 216 indicating a physical alignment of the displays 214a and 214b based on the position of the indicators 412 and 414 or 422 and 424. Finally, the configuration interface 222 computes the placement of the displays 214a and 214b based on the indicated alignment, and in step 305, the window 426 provided for display on each of the displays is arranged and therefore aligned based on the received indication, as provided in the example illustration 425 of FIG. 4D. The process 300 ends in step 306.

FIGS. 4E-4H provide example illustrations of configuring two displays 214a and 214b having different pixel densities, namely a first display 214a having a pixel density of 100 pixels per inch (“ppi”) and a second display 214b having a higher pixel density of 150 ppi. In certain aspects, if a pixel density of one or many displays is not known to the configuration interface 222, the missing pixel density information can be provided by a user or by comparing a size of graphical objects between a display having a known pixel density and a display having an unknown pixel density. With reference to the process 300 of FIG. 3, the process 300 begins by proceeding from beginning step 301 when the configuration interface 222 is initiated. When the configuration interface 222 is initiated, the configuration of the displays 214a and 214b is not aligned, as illustrated by the first mouse trail 431 that does not jump positions between the two displays 214a and 214b, and the second mouse trail 432 that does jump positions between the two displays 214a and 214b, as provided in the illustration 430 of FIG. 4E.

Next, in step 302, a first pair of circular indicators 436 and 438 and a second pair of circular indicators 437 and 439 are generated by a user at aligned positions on proximate edges of the displays 214a and 214b as provided in the example illustration 435 of FIG. 4F. The position of the generated circular indicators 412 and 414 indicates a selection of proximate edges of the displays 214a and 214b in step 303.

Alternatively, for steps 302 and 303, in step 302 a rectangular bar indicator 441 and 442 may be provided for display on each of displays 214a and 214b. In step 303, the user repositions and adjusts the size of the rectangular bar indicators 441 and 442 on proximate edges of the displays 214a and 214b until the position and size of the rectangular bar indicators 441 and 442 are in alignment.

Moving forward in the process 300, in step 304, an indication that the circular indicators 436-439 or the rectangular bar indicators 441 and 442 have been aligned on the displays 214a and 214b is received by the user hitting enter on the keyboard input device 216 indicating a physical alignment of the displays 214a and 214b based on the position of the circular indicators 436-439 or the position and size of the rectangular bar indicators 441 and 442. Finally, in step 305, a window provided for display on each of the displays is arranged and therefore aligned (e.g., in position and size) in its two portions 446a and 446b based on the received indication, as provided in the example illustration 445 of FIG. 4H, and the process 300 ends in step 306.

Even after alignment of the two displays 214a and 214b having different pixel densities, an object, such as a cursor, can move differently on each of the displays 214a and 214b because of the differing pixel densities. For example, a mouse, associated with a cursor, that is moved a distance of x can by default cause the cursor to move further on a display having lower pixel density than a display having a higher pixel density. This difference can be addressed in several ways.

In one aspect, the speed of the cursor or other graphical object may be adjusted to a substantially similar speed across displays during movement of a graphical object between displays having differing pixel densities.

In another aspect, movement of graphical objects between displays having differing pixel densities can be normalized to a substantially similar speed by scaling each of the displays to match pixel density. The uniform pixel density can be selected automatically, such as by selecting the pixel density of a largest or most dense display, or by a user.

In a further aspect, a difference in graphical object movement speed between displays having differing pixel densities can be indicated by animating or otherwise visually distinguishing a graphical object when it approaches a boundary between displays having differing pixel densities. For example, a cursor moved across an edge of one display may be animated in order to call attention to the cursor's location while the cursor is near proximate edges of either side of the displays having different densities.

In yet a further aspect, a difference in graphical object movement speed between displays having differing pixel densities can be indicated for particularly large graphical objects, such as photos, by selectively drawing visual attention to a cursor associated with the large graphical object. For example, when a cursor with no other graphical object or a small graphical object is moved across displays having differing pixel densities, then the cursor may be animated near one or both proximate edges of the displays. When a cursor and a large graphical object are moved across displays having differing pixel densities, then just the cursor may be animated near one or both proximate edges of the displays.

FIGS. 4I to 4O provide example illustrations for configuring a client 110 having at least three displays 214a, 214b, and 214c. Specifically, FIGS. 4I to 4K provide a first example approach for configuring a client 110 having at least three displays 214a, 214b, and 214c, and FIGS. 4L to 4O provide a second example approach for configuring a client 110 having at least three displays 214a, 214b, and 214c.

With reference to the first example approach for configuring a client 110 having at least three displays 214a, 214b, and 214c, each of the displays 214a, 214b, and 214c displays a message 451 to a user instructing the user to select a bar 452a, 452b, 452c, or 452d on an edge of one of the displays 214a, 214b, and 214c that is next to a bar on an edge of another one of the displays 214a, 214b, and 214c, as provided in the example illustration 450 of FIG. 4I. When the user selects a bar 452a on an edge of a display 214b, the other bars 452b, 452c, and 452d provided on the display 214b are dimmed or otherwise removed, and bars 457a, 457b, 458a, and 458b are preserved on parallel edges of the remaining displays 214c and 214b, as provided in the example illustration 455 of FIG. 4J. The user is prompted to select a bar on an edge the remaining displays 214c and 214b that is closest to the selected bar 452a on the edge of the initially selected display 214b. Once the user has selected a bar 458b on an edge of a remaining display 214b, a first pair of circular indicators 436 and 438 and a second pair of circular indicators 437 and 439 are generated for the user to align as discussed above with reference to FIG. 4F in order to align the two displays 214a and 214b. The bar selection process may then repeat to align the remaining display 214c with the configured displays 214a and 214b.

With reference to the second example approach for configuring a client 110 having at least three displays 214a, 214b, and 214c, each of the displays 214a, 214b, and 214c displays a message 466a to a user instructing the user to click within one of the displays 214a, 214b, and 214c that is next to another one of the displays 214a, 214b, and 214c as provided in the example illustration 465 of FIG. 4L. When the user clicks in the middle display 214b, the message 466a is removed from the middle display 214b but remains on the remaining displays 214a and 214c, as provided in the example illustration 470 of FIG. 4M. As provided in the example illustration 480 of FIG. 4O, once the two displays 214a and 214b are selected for alignment, bars 482a, 482b, 482c, and 482d are provided for display on one of the two selected displays 214a in order to align the selected display 214a with the other selected display 214b as discussed above with reference to FIG. 4I. The display selection process may then repeat to align the remaining display 214c with the configured displays 214a and 214b.

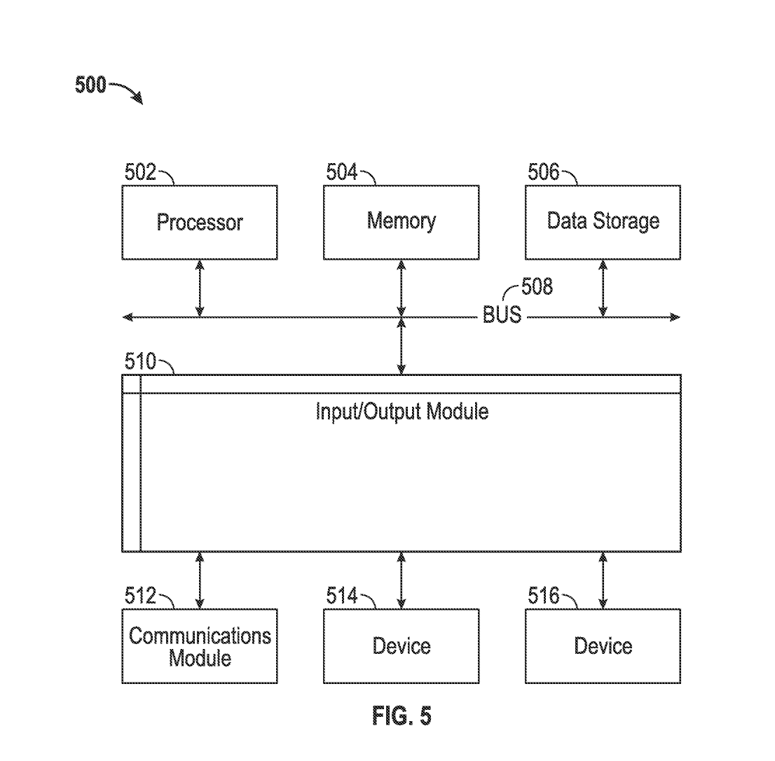

FIG. 5 is a block diagram illustrating an example computer system 500 with which the client 110 of FIG. can be implemented. In certain aspects, the computer system 500 may be implemented using hardware or a combination of software and hardware, either in a dedicated server, or integrated into another entity, or distributed across multiple entities.

Computer system 500 (e.g., client 110) includes a bus 508 or other communication mechanism for communicating information, and a processor 502 (e.g., processor 212) coupled with bus 508 for processing information. By way of example, the computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504 (e.g., memory 220), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, i.e., one or more modules of computer program instructions encoded on a computer readable medium for execution by, or to control the operation of, the computer system 500, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, embeddable languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. The input/output module 510 can be any input/output module. Example input/output modules 510 include data ports such as USB ports. The input/output module 510 is configured to connect to a communications module 512. Example communications modules 512 include networking interface cards, such as Ethernet cards and modems. In certain aspects, the input/output module 510 is configured to connect to a plurality of devices, such as an input device 514 (e.g., input device 216) and/or an output device 516 (e.g., display devices 214a to 214n). Example input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output devices 516 include display devices, such as a LED (light emitting diode), CRT (cathode ray tube), or LCD (liquid crystal display) screen, for displaying information to the user.

According to one aspect of the present disclosure, the client 110 can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., network 150) can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computing system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions or data to processor 502 for execution. Such a medium may take many forms, including, but not limited to, non-volatile media, volatile media, and transmission media. Non-volatile media include, for example, optical disks, magnetic disks, or flash memory, such as data storage device 506. Volatile media include dynamic memory, such as memory 504. Transmission media include coaxial cables, copper wire, and fiber optics, including the wires that include bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Terms such as “top,” “bottom,” “left,” “right,” “middle,” and the like as used in this disclosure should be understood as referring to an arbitrary frame of reference, rather than to the ordinary gravitational frame of reference.

Furthermore, to the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The subject matter of this specification has been described in terms of particular aspects, but other aspects can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

These and other implementations are within the scope of the following claims.

1. A computer-implemented method for configuring multiple displays for use with a device, the method comprising:
providing, for display, an interface for a user to select at least two displays, from among a plurality of displays, to configure, the interface comprising, for each of the plurality of displays, at least one indicator, and each of the plurality of displays having at least one edge proximal to an edge of another of the plurality of displays;
receiving a selection by the user in the interface of an indicator for each of a pair of proximate edges of the at least two of the plurality of the displays to configure;
receiving an indication that the selected indicators have been aligned on the at least two of the plurality of displays to indicate a physical alignment of the at least two of the plurality of displays; and
arranging content provided for display on each of the at least two of the plurality of displays based on the received indication.

2. The method of claim 1, wherein the at least two of the plurality of displays each comprises different pixel densities.

3. The method of claim 2, wherein each of the at least two of the plurality of displays each comprises two indicators, and wherein the received indication comprises an indication that each selected indicator on one of the at least two plurality of displays is aligned with a corresponding selected indicator on the other of the at least two plurality of displays.

4. The method of claim 2, wherein each selected indicator has a corresponding length, and wherein the received indication comprises an indication that the length of each of the selected indicators matches, and the position of each of the selected indicators is in alignment.

5. The method of claim 1, wherein the indicator is an arrow, and wherein the received indication comprises an indication that each arrow is positioned in alignment with at least one other arrow on another display.

6. The method of claim 1, wherein the indicator comprises a graphical object generated by a user in a position selected by the user.

7. The method of claim 1, further comprising receiving an input to identify each of the at least two of the plurality of displays to be arranged.

8. The method of claim 1, the method further comprising:
providing, for display, at least one marker on each of the plurality of displays;
receiving a selection of a marker on the at least two of the plurality of displays, the selected markers indicating proximate edges for the at least two of the plurality of displays; and
providing the indicator on each of the proximate edges for the at least two of the plurality of displays.

9. The method of claim 1, wherein a marker is provided for each edge of the plurality of displays, and wherein, in response to a selection of a marker on a first edge of the at least two of the plurality of displays, markers on non-opposing edges to the first edge are removed from the display.

10. A system for configuring multiple displays for use with a device, the system comprising:
a memory comprising instructions;
a processor configured to execute the instructions to:
provide, for display, an interface for a user to select at least two displays, from among a plurality of displays, to configure, the interface comprising, for each of the plurality of displays, at least one indicator, and each of the plurality of displays having at least one edge proximal to an edge of another of the plurality of displays;
receive a selection by the user in the interface of an indicator comprising a visual marker for each of a pair of proximate edges of the at least two of the plurality of the displays to configure;
receive an indication that the selected indicators have been aligned on the at least two of the plurality of displays to indicate a physical alignment of the at least two of the plurality of displays; and
arrange content provided for display on each of the at least two of the plurality of displays based on the received indication.

11. The system of claim 10, wherein the at least two of the plurality of displays each comprises different pixel densities.

12. The system of claim 11, wherein each of the at least two of the plurality of displays each comprises two indicators, and wherein the received indication comprises an indication that each selected indicator on one of the at least two of the plurality of displays is aligned with a corresponding selected indicator on the other of the at least two of the plurality of displays.

13. The system of claim 11, wherein each selected indicator has a corresponding length, and wherein the received indication comprises an indication that the length of each of the selected indicators matches and the position of each of the selected indicators is in alignment.

14. The system of claim 10, wherein the visual marker comprises an arrow, and wherein the received indication comprises an indication that each arrow is positioned in alignment with at least one other arrow on another display.

15. The system of claim 10, wherein the visual marker is generated by a user in a position selected by the user.

16. The system of claim 10, wherein the processor is further configured to execute the instructions to receive an input to identify each of the at least two of the plurality of displays to be arranged.

17. The system of claim 10, wherein the processor is further configured to execute the instructions to:
provide, for display, at least one marker on each of the plurality of displays;
receive a selection of a marker on each of the at least two of the plurality of displays, the selected markers indicating proximate edges for the at least two of the plurality of displays; and
provide the indicator on each of the proximate edges for the at least two of the plurality of displays.

18. The system of claim 10, wherein a marker is provided for each edge of the plurality of displays, and wherein, in response to a selection of a marker on a first edge of the at least two of the plurality of displays, markers on non-opposing edges to the first edge are removed from the display.

19. A non transitory machine-readable storage medium comprising machine-readable instructions for causing a processor to execute a method for configuring multiple displays for use with a device, the method comprising:
providing, for display, an interface fir a user to select at least two displays, from among a plurality of displays, to configure, the interface comprising, for each of the plurality of displays, at least one indicator, and each of the plurality of displays having at least one edge proximal to an edge of another of the plurality of displays;
receiving a selection by the user in the interface of an indicator for each of a pair of proximate edges of the at least two of the plurality of the displays to configure;
receiving an indication that the selected indicators have been aligned on the at least two of the plurality of displays to indicate a physical alignment of the at least two of the plurality of displays; and
arranging content provided for display on each of the at least two of the plurality of displays based on the received indication,
wherein the at least two of the plurality of displays each comprise different pixel densities.

20. The non-transitory machine-readable storage medium of claim 19, wherein each of the at least two of the plurality of displays each comprises two indicators, and wherein the received indication comprises an indication that each selected indicator on one of the at least two plurality of displays is aligned with a corresponding selected indicator on the other of the at least two plurality of displays.
